(19) United States
(12) Patent Application Publication
(10) Pub. No.: US 2005/0289052 A1
(43) Pub. Date: Dec. 29, 2005

(54) System and method for secure telephone and computer transactions

(76) Inventor: John Wankmueller, Great Neck, NY (US)

Correspondence Address: BAKER & BOTTS, 30 ROCKEFELLER PLAZA, NEW YORK, NY, 10112, US

(21) Appl. No.: 11/042,864

(22) Filed: Jan. 24, 2005

Related U.S. Application Data
(63) Continuation-in-part of application No. 10/764,099, filed on Jan. 23, 2004.
(60) Provisional application No. 60/442,143, filed on Jan. 23, 2003.
(60) Provisional application No. 60/538,761, filed on Jan. 23, 2004.

(51) Int. Cl. G06F 17/60

(52) U.S. Cl. 705/40

(57) ABSTRACT

A secure electronic payment system and method for conducting a secure transaction using authentication is provided. A merchant's computer transmits an authorization request to an access control server. The access control obtains authentication to confirm the identity of the purchaser, via e.g., an electronic form or interactive voice response system. The access control server then transmits a response to the merchant's computer. If the purchaser is authorized to access the account, payment is processed by the merchant and the transaction is completed.

### CROSS-REFERENCE TO RELATED APPLICATIONS

This application is a continuation-in-part of U.S. patent application Ser. No. 10/764,099, entitled “System and Method for Secure Telephone And Computer Transactions Using Voice Authentication,” filed on Jan. 23, 2004 (claiming priority to U.S. Provisional Patent Application No. 60/442,143, filed Jan. 23, 2003), which is fully incorporated herein by reference. This application also claims priority to U.S. Provisional Patent Application No. 60/538,761, filed Jan. 23, 2004, which is fully incorporated herein by reference.

### BACKGROUND OF THE INVENTION

Credit cards and other forms of payment cards were originally designed for use during in-person transactions, during which the card may provide both a means for payment and a means for authentication of the cardholder. In addition to having actual possession of the card, the purchaser must also provide a signature which may be compared with the signature on the back of the card.

The major drawback in telephone order transactions is that the vast majority are not authenticated in the manner described above. Accordingly, the number of fraudulent transactions and chargebacks associated with credit/payment cards are increased as a result. Additionally, consumers may be concerned about the potential hazards of providing personal payment information over a telephone to a possibly unknown and unidentifiable individual.

On-line shopping, or e-commerce, suffers many of the same problems. On-line shopping offers unprecedented ease and convenience for consumers, while enabling merchants to reduce costs and obtain new customers. However, many consumers have been reluctant to take advantage of these benefits due to fear of theft of sensitive information such as credit card numbers. Efforts have been made to increase the security of such information transmitted across the internet. For example, in the secure socket layer (SSL) technique, messages sent between the consumer and the merchant are encrypted, thereby making it more difficult for a third party to intercept and use the information. However, this method does not provide the merchant with any verification of the identity of the consumer. Accordingly, if a third party were to obtain a credit card number by other fraudulent means such as theft of physical credit card, the SSL method would not prevent the third party from fraudulently using the stolen information.

Secure Electronic Transaction (SET™) techniques attempt to solve the foregoing problems by using digital certificates to authenticate the consumer/account holder, the merchant, and the credit card issuer. Each certificate is issued by a trusted certificate authority. While SET™ is currently the most secure way to handle payments over the Internet, it requires digital certificates and cryptographic software to be installed and operated on the account holder's computer.

In fact, most prior art secure electronic commerce systems require consumers to install special software on their computers. Yet, many consumers are reluctant to install such software and, in any case, a specialized account holder application may not be compatible with a wide variety of account holder access devices—e.g., personal computers, personal digital assistants, and mobile communication devices such as mobile telephones. As a result, it has been difficult for some secure electronic commerce systems to gain widespread acceptance among consumers.

Accordingly, there exists a need in the art for a system and method for confirming the identity of a customer in conjunction with a telephone or on-line purchase in order to facilitate a more secure transaction.

### SUMMARY OF THE INVENTION

It is therefore an object of the present invention to provide a method of conducting secure telephone and on-line transactions.

This and other objects are accomplished by a system and method for conducting a secure transaction which preferably includes the steps of providing a database including first authentication information associated with a holder of the payment account, providing payment account information associated with the payment account, the payment account information to be used for conducting the transaction, transmitting an authentication request including the payment account information to an access control server, receiving by a merchant information including authentication instructions, receiving second authentication information from the customer, and comparing the first and the second authentication information to determine whether the transaction is authorized by the holder of the payment account.

The objects of the invention are further accomplished by a system and method for conducting a secure transaction which preferably includes the steps of receiving payment account information associated with the payment account, the payment account information to be used for conducting the transaction, transmitting an authentication request including the payment account information to an access control server, the authentication request triggering automatically by the server the transmission of data used to display an electronic form, receiving via the electronic form authentication information from the holder, authenticating the holder for purposes of authorizing the transaction, and authorizing said transaction.

The objects of the invention are further still accomplished by a method for conducting a secure transaction which preferably includes the steps of providing a database including at least a first set of authentication information associated with a holder of said payment account, receiving payment account information associated with the payment account, the payment account information to be used for conducting the transaction, receiving an authentication request including at least the payment account information in connection with conducting the transaction, triggering automatically the display of an electronic form, receiving a second set of authentication information from the holder of the payment account, inputting the second set of authentication information into the electronic form, and comparing the first set of authentication information to the second set of authentication information to determine whether the transaction is authorized by the holder of the payment account.

The objects of the invention are further accomplished by a system for conducting a secure transaction which preferably includes a server computer subsystem, the server computer subsystem including information relating to at least one payment account including at least a first set of authentication information relating to an account holder of the payment account, an automated voice response subsystem, and an authentication subsystem, wherein the automated voice response subsystem connects a call to the account holder to obtain a second set of authentication information, and further wherein the authentication subsystem compares the first set of authentication information to the second set of authentication information to determine whether the transaction is authorized by the account holder.

The objects of the invention are further accomplished by a system for conducting a secure transaction which preferably includes a server computer subsystem, the server computer subsystem including information relating to at least one payment account including at least a first set of authentication information relating to an account holder of the payment account, and a virtual electronic form subsystem, wherein the virtual electronic form subsystem provides an electronic form to the merchant, the electronic form receiving a second set of authentication information from the merchant, and further wherein the server computer subsystem compares the first set of authentication information to the second set of authentication information to determine whether the transaction is authorized by the account holder.

### BRIEF DESCRIPTION OF THE DRAWINGS

Further objects, features, and advantages of the present invention will become apparent from the following detailed description taken in conjunction with the accompanying figures showing illustrative embodiments of the invention, in which:

FIG. 1 is a block diagram illustrating an additional exemplary system for conducting a payment transaction in accordance with the present invention;

FIG. 2A is a flow diagram illustrating an exemplary procedure for conducting a payment transaction in accordance with the present invention;

FIG. 2B is a flow diagram illustrating an exemplary procedure for conducting a payment transaction in accordance with the present invention;

FIG. 3A is a flow diagram illustrating an exemplary procedure for conducting a payment transaction in accordance with the present invention;

FIG. 3B is a flow diagram illustrating an exemplary procedure for conducting a payment transaction in accordance with the present invention;

FIG. 4 is a block diagram illustrating an exemplary system for conducting a payment transaction in accordance with the present invention; and

FIG. 5 is a block diagram illustrating an exemplary system for conducting a payment transaction in accordance with the present invention.

Throughout the figures, unless otherwise stated, the same reference numerals and characters are used to denote like features, elements, components, or portions of the illustrated embodiments.

### DETAILED DESCRIPTION OF THE INVENTION

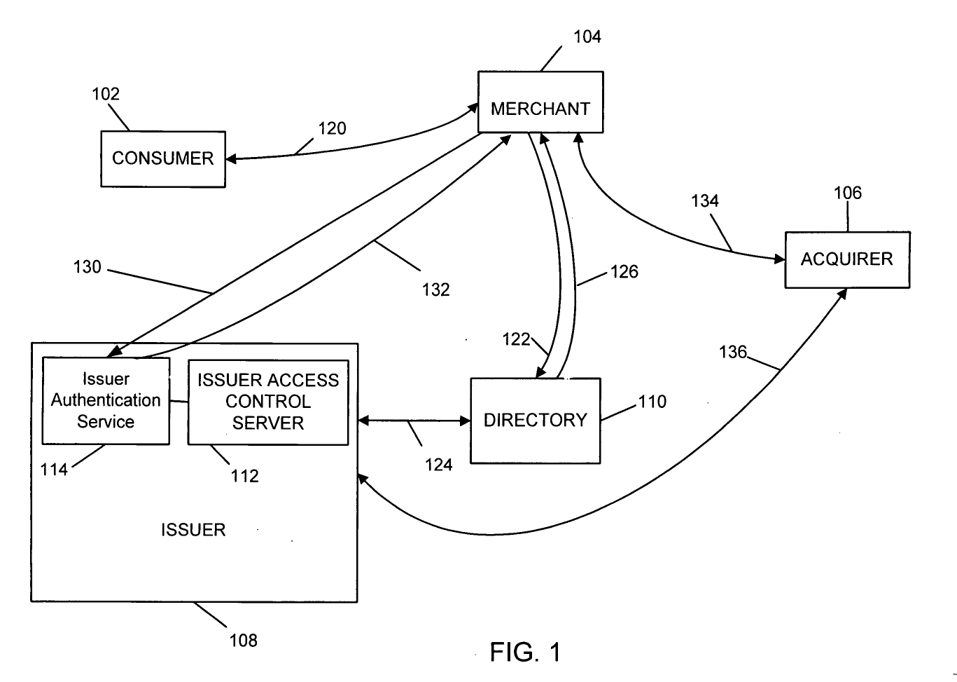

FIG. 1 illustrates an exemplary method for performing secure payment transactions in accordance with the present invention. The system includes a consumer 102, a merchant 104 selling goods and/or services, an acquirer 106—typically the merchant's acquiring bank—and an issuer 108—typically a financial institution such as a bank—that has issued a payment account being used to conduct a transaction with the merchant. The system may also include a cardholder directory/database 110 which stores information regarding the cardholder's account. The database 110 is operated by a payment organization such as the MasterCard® payment organization and is preferably a server computer connected to a network such as the Internet. The system preferably further includes, as part of the issuer system 108, an issuer access control server 112 which is mated to an issuer virtual authentication service 114, in accordance with an exemplary embodiment of the present invention.

The consumer 102 may be conducting the transaction 120 with the merchant 104 via telephone. The system and method of the present invention may be implemented regardless of the means by which the transaction between the user and merchant is conducted, and the present invention accordingly shall not be limited to telephone transactions. The payment account used to pay for the goods or services rendered by merchant 104 is typically a credit card account, a debit card account, and/or any other type of payment card account. The account can, but need not be, associated with a physical card. For example, the payment account can be associated with a virtual card which can be stored electronically on a computing device used by consumer 102. The consumer can, but need not be, the account holder, and as used herein the term “holder” includes one or more individuals associated with and authorized to use a payment account or payment card.

In one exemplary embodiment of a method according to the present invention, transaction 120 is conducted between a consumer 102 and a merchant 104, using a payment card such as a MasterCard® credit card. Consumer 102 selects the goods/services to purchase, and places an order with merchant 104, thereby providing merchant 104 with payment account information, including MasterCard® credit card information such as account number, expiration date, and name of the cardholder. Merchant 104, using a computer system connected to a network, may transmit a query 122 to a directory 110 such as a MasterCard® directory to determine the cardholder's participation in authentication services.

The directory 110 then preferably communicates 124 with the issuer 108 to verify cardholder participation. This verification 124 may be conducted with an issuer access control server 112, which preferably is part of an issuer system 108. Assuming the cardholder is verified as utilizing authentication services such as those described in accordance with the present invention, directory 110 may transmit to the merchant 104 an enrollment verification message 126 verifying the cardholder's enrollment for authentication services. After the merchant 104 receives the enrollment verification message from the directory 110, the merchant 104 may inform the consumer 102 that authentication will be performed, and that the transaction will be completed upon receipt of authorization. The merchant 104 preferably then transmits to issuer access control server 112 via issuer authentication service 114 a request for authentication 130.

Authentication may now be performed by one of several methods depending upon the specific implementation of the present invention. For example, in the context of a telephone order authentication system, the merchant 104 may prompt the cardholder for data over the telephone line (or via internet, in the case of an on-line transaction), which data may be used to perform authentication. However, several other procedures for authentication may also be implemented within the scope of the present invention.

For example, in one exemplary embodiment, extensions to the transaction's core protocol (e.g., the 3-D Secure protocol, described in greater detail hereinafter and in related applications referenced hereinafter) may be implemented, and the data necessary for authentication may be carried within extension “tags” of the messages exchanged (such as the VEReq, VERes and PAReq messages) during the course of an otherwise-standard 3-D Secure transaction.

In another exemplary embodiment in accordance with a system and method of the present invention, the core protocol may be implemented without modification. In one such embodiment, all data and tags according to the 3-D Secure protocol may remain unchanged. However, in order to perform the authentication steps, a merchant may query a second directory to determine independently whether an issuer participates in authentication. If the issuer does participate in authentication, the merchant may direct the cardholder to call an Interactive Voice Response (“IVR”) System in order to complete authentication.

In yet another exemplary embodiment in accordance with a system and method of the present invention, as discussed above, the core protocol may remain largely unchanged, with minor modification which would allow the merchant, on behalf of the cardholder, to enter data into the authentication system. Such a system may be beneficial particularly for telephone transactions wherein the cardholder may not have access to a computer and may not wish to terminate the telephone call with the merchant (to provide the necessary authentication data to the issuer) until the transaction has been completed. In one such embodiment, modification may be made to the 3-D Secure protocol such that the Access Control Server URL field in the VERes message may be modified to prompt a merchant to enter authentication data on behalf of the cardholder. Notably, the cardholder may preferably be the consumer 102 or, alternatively, the consumer may be a purchaser who is authorized by the cardholder to pay for the transaction with the merchant. The latter case may apply where, for example, an agent of the cardholder is directed to purchase goods or services on behalf of the cardholder. As used herein, the term “holder” includes any of these individuals.

Regardless of the procedure used to obtain the required information from the cardholder, the information requested from the cardholder for authentication purposes may include any information on file with the issuer 108 and which may be used to verify the identity of the caller/purchaser, i.e., that the caller/purchaser is the cardholder. One such example would be to utilize an EMV Chip Card and card reader to provide the merchant, issuer, or an automated call center with the Cardholder's SecureCode.™ Other procedures for verification as would be known to those skilled in the art may include use of dynamic security questions, Dual Tone Multiple-Frequency (“DTMF”) user input by the caller/purchaser, voice biometrics analysis, or any other method for confirming that the caller/purchaser is the cardholder.

Continuing with the description of the exemplary embodiment of a system according to the present invention, if the issuer access control server 112 determines that the transaction has been properly authenticated, the access control server 112 preferably transmits an authentication response message 132 through the issuer authentication service 114 to the merchant 104, indicating that the transaction has been authenticated. Thereafter, the transaction may be completed as would otherwise be known in the art, e.g., through communications 134 between the merchant 104 and an acquirer 106 and communications 136 between acquirer 106 and issuer 108. An exemplary embodiment of the present invention may be implemented in conjunction with security protocols such as the 3-D (or three domain) Secure authentication protocol. The 3-D Secure authentication protocol is known in the art and has generally been adopted and implemented across the payment industry. The present invention may be implemented in conjunction with MasterCard®'s implementation of 3-D Secure as described in U.S. Provisional Patent Application No. 60/477,187, entitled “Algorithm for use in a Secure Payment Application,” filed on Jun. 10, 2003, which is incorporated herein by reference in its entirety, and related applications. However, it is noted that the scope of the present invention shall not be limited to this implementation of a system and method for secure transactions using the 3-D Secure protocol; the concepts described herein may be broadly applied in numerous ways as would be apparent to one skilled in the related art.

Additional detail regarding completion of the transaction using MasterCard®'s implementation of the 3-D Secure protocol can be found in the following applications, all of which are also incorporated herein by reference in their entirety: U.S. patent application Ser. No. 09/963,274, entitled “A Universal and Interoperable System and Method Utilizing a Universal Cardholder Authentication Field (UCAF) For Authentication Data Collection and Validation,” filed on Sep. 26, 2001; U.S. Provisional Patent Application No. 60/280,776, entitled “System and Method for Secure Payment Application (SPA) and Universal Cardholder Authentication,” filed on Apr. 2, 2001; U.S. Provisional Patent Application No. 60/295,630, entitled “Method and Process for a Secure Payment Application Using a Universal Cardholder Authentication Field,” filed on Jun. 4, 2001; U.S. Provisional Patent Application No. 60/307,575, entitled “Method and System for Conducting Transactions Over a Communication Network Using a Secure Payment Application,” filed on Jul. 24, 2001; U.S. patent application Ser. No. 09/886,486, entitled “Method and System for Conducting Secure Payments Over a Computer Network Without a Pseudo or Proxy Account Number,” filed on Jun. 22, 2001; U.S. patent application Ser. No. 09/886,485, entitled “Method and System for Conducting Secure Payments Over a Computer Network,” filed on Jun. 22, 2001; U.S. patent application Ser. No. 10/096,271, entitled “System and Method for Conducting Secure Payment Transactions,” filed on Mar. 11, 2002; and U.S. Provisional Patent Application No. 60/352,968, entitled “MasterCard UCAF™ and SPA™ Client-less Solution,” filed on Jan. 30, 2002.

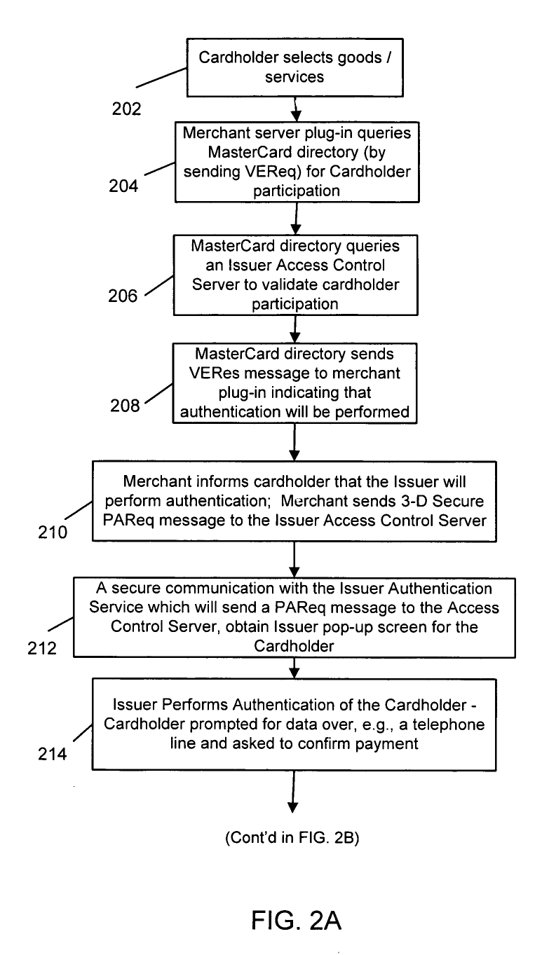

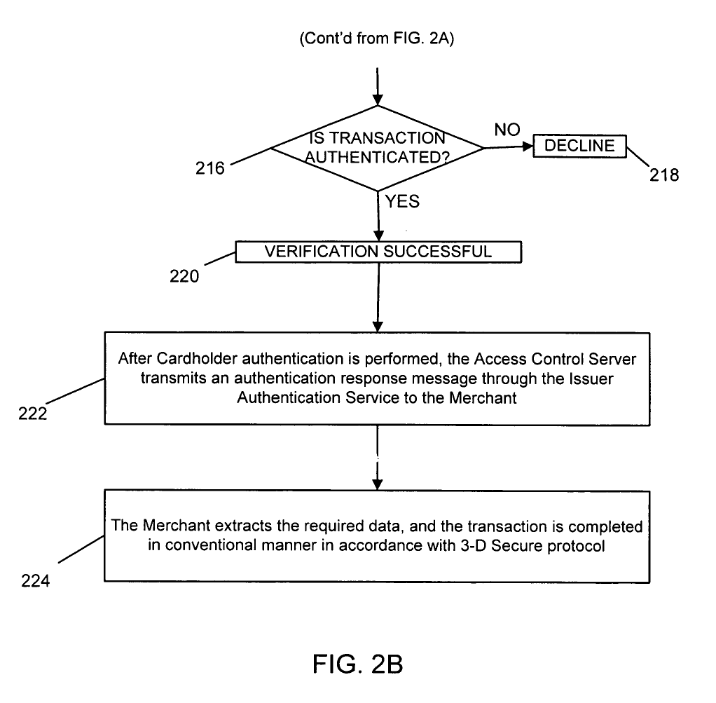

FIGS. 2A and 2B illustrate an exemplary method for operating the payment transaction system illustrated in FIG. 1 using authentication, in conjunction with the 3-D Secure authentication protocol. First, a consumer selects goods and/or services which are the subject of the transaction (Step 202). Next, the merchant computer system queries a MasterCard® directory to verify cardholder participation in the voice authentication system (Step 204). This query may preferably be in the form of a 3-D Secure Verify Enrollment Request (VEReq) message, as described in detail in the references incorporated hereinabove. Notably, the merchant system may be configured with a software plug-in to facilitate compatibility and efficient interoperability with, e.g., the issuer (e.g., via a plug-in on the issuer side such as an issuer virtual pop-up service) and directory systems. This plug-in may be used to translate data from the merchant system into a format suitable for use by the issuer system, and vice-versa. Such a plug-in would be useful to facilitate upgrading a merchant's current system for use with a system and method in accordance with the present invention, though such an upgrade is not necessary within the scope of the present invention. Additionally, the plug-in may be composed of software, hardware, or some combination thereof.

Next, the MasterCard® directory communicates with an Issuer Access Control Server to verify cardholder participation (Step 206). Assuming cardholder participation is verified, the MasterCard® directory then transmits an enrollment verification message to the merchant computer system (Step 208), indicating that Application No. 60/352,968, entitled “MasterCard UCAF™ and SPA™ Client-less Solution,” filed on Jan. 30, 2002.

FIGS. 2A and 2B illustrate an exemplary method for operating the payment transaction system illustrated in FIG. 1 using authentication, in conjunction with the 3-D Secure authentication protocol. First, a consumer selects goods and/or services which are the subject of the transaction (Step 202). Next, the merchant computer system queries a MasterCard® directory to verify cardholder participation in the voice authentication system (Step 204). This query may preferably be in the form of a 3-D Secure Verify Enrollment Request (VEReq) message, as described in detail in the references incorporated hereinabove. Notably, the merchant system may be configured with a software plug-in to facilitate compatibility and efficient interoperability with, e.g., the issuer (e.g., via a plug-in on the issuer side such as an issuer virtual pop-up service) and directory systems. This plug-in may be used to translate data from the merchant system into a format suitable for use by the issuer system, and vice-versa. Such a plug-in would be useful to facilitate upgrading a merchant's current system for use with a system and method in accordance with the present invention, though such an upgrade is not necessary within the scope of the present invention. Additionally, the plug-in may be composed of software, hardware, or some combination thereof.

Next, the MasterCard® directory communicates with an Issuer Access Control Server to verify cardholder participation (Step 206). Assuming cardholder participation is verified, the MasterCard® directory then transmits an enrollment verification message to the merchant computer system (Step 208), indicating that authentication will be performed (Step 214). The enrollment verification message may preferably be in the form of a Verify Enrollment Response (VERes) message in accordance with MasterCard®'s implementation of 3-D Secure as referenced above. Also as described above, this message may be received by a software plug-in in the merchant system, which plug-in provides interoperability with the merchant's current system.

After the merchant receives the VERes from the MasterCard® directory, which validated cardholder participation, the merchant may transmit an authentication request message (Step 210) to the issuer system. The request message may preferably be a 3-D Secure Payer Authorization Request (PAReq) message, and may be received by the Issuer's Access Control Server. The PAReq message preferably includes a plurality of data fields, e.g., including information which will enable the issuer to perform authentication, and may also contain a “Request Expiration” field, which may be used to indicate the date and time when the merchant plug-in will allow the transaction to time out if no Payer Authentication Response (PARes) is received from the Issuer Access Control Server by the merchant plug-in.

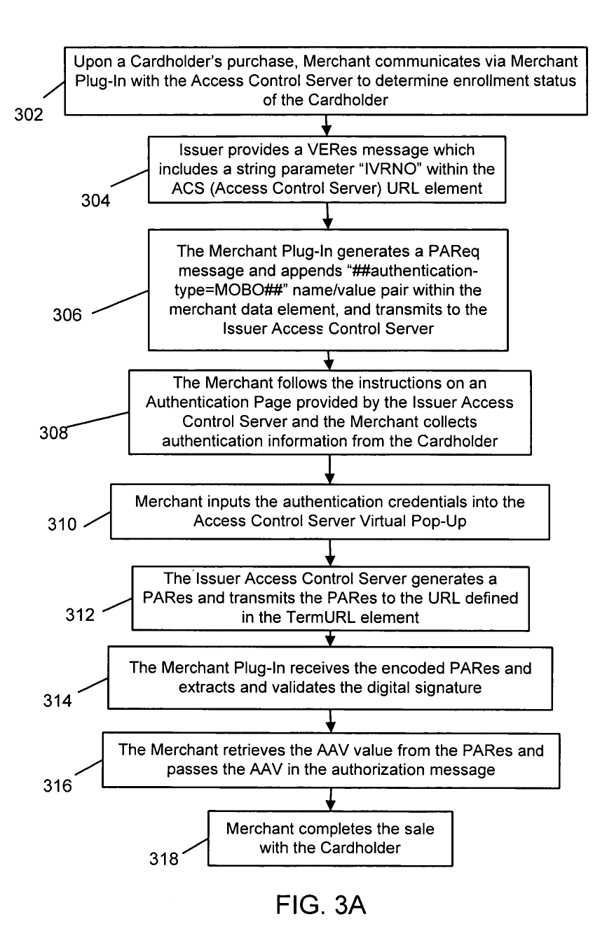

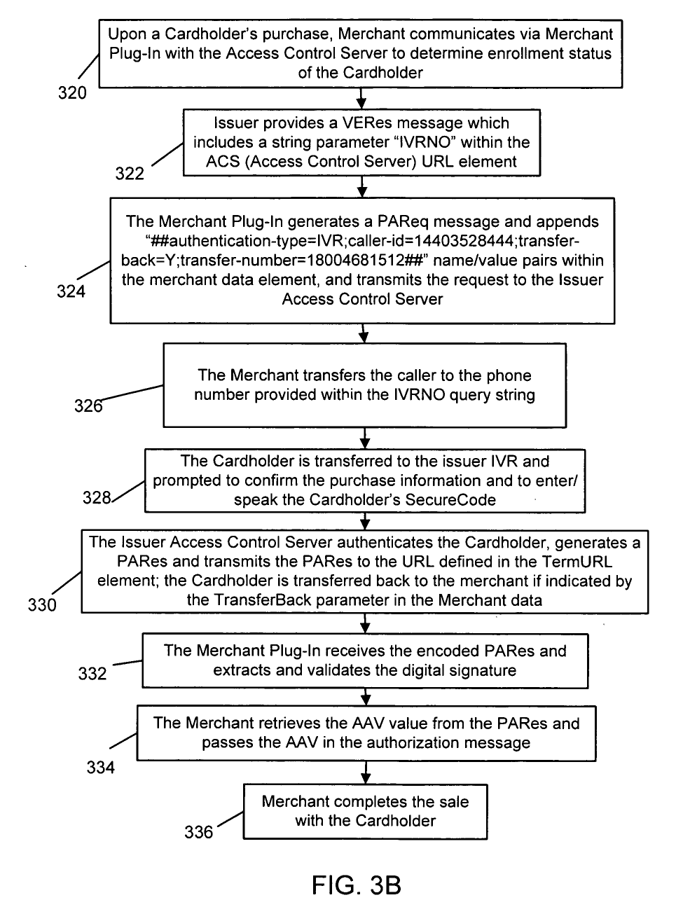

After the Issuer Access Control Server receives the PAReq message, authentication may be commenced. In one exemplary embodiment of the present invention, the issuer authentication service may be a “Virtual Pop-Up” Service which prepares an electronic form for the Cardholder (Step 212) and transmits the form to the Merchant for entry of the Cardholder's data. The Merchant may then request the caller/purchaser's pertinent data over the telephone and enter the information into the form and transmit the data to the issuer for authentication of the Cardholder (Step 214) (this exemplary embodiment may be termed a Merchant-On-Behalf-Of, or “MOBO” approach, described more fully hereinafter in connection with FIG. 3A). Upon completion of the authentication procedure, described more fully in conjunction with FIGS. 3A and 3B below, an authentication response is generated by the Issuer Access Control Server and transmitted to the merchant (Step 222), indicating the result of the authentication procedure. The authentication response may be in the form of, e.g., a Payer Authentication Response (PARes) in accordance with the 3-D Secure protocol.

If authentication fails or times out, the transaction may still be commenced depending on the reason for failure and configuration of the particular embodiment of the system according to the present invention. However, if authentication fails due to an apparent authorization problem, signaling a potential fraudulent transaction, authentication may be declined (Step 218) and the transaction cancelled. In contrast, if authentication completes successfully (Step 220), then the Access Control Server may transmit an authentication response to the Merchant (Step 222) and the transaction may be completed in the conventional manner in accordance with the 3-D Secure protocol (Step 224).

An exemplary procedure for performing authentication (Step 214 of FIG. 2A) is illustrated in FIG. 3A. In this exemplary embodiment, a Merchant-On-Behalf-Of (“MOBO”) approach is implemented, i.e., the Merchant requests the authentication information from a Cardholder (e.g., over the telephone during a telephone transaction) and enters the authentication information into the system via an electronic form or other means. Upon a Cardholder's purchase, the Merchant may communicate via a Merchant Plug-In with the Issuer Access Control Server to determine whether the Cardholder is enrolled in authentication services (Step 302). In response, the Issuer may transmit a VERes message which includes a query string parameter “IVRNO” within the ACS (Access Control Server) URL element (Step 304). For example, the following sample URL may be included in the VERes message:
https://securecode.issuer.com/authenticate.asp?IVRNO=MOBO
   This additional query string parameter appended to the ACS URL is detected by the Merchant Plug-In and indicates to a Merchant that the Cardholder is enrolled for telephone authentication and that the Merchant must perform a MOBO authentication using the prescribed means for authentication (e.g., SecureCode™).

Next, the Merchant Plug-In may generate a PAReq message and append a name/value pair within the merchant data (such as “##authentication-type=MOBO##”) The Merchant may then transmit the merchant data to the Issuer Access Control Server (Step 306). This name/value pair indicates to the Access Control Server that the PAReq transmitted by the Merchant is for telephone authentication as opposed to e-commerce/on-line transaction authentication. The Merchant may then follow the instructions provided on an authentication web page provided by the Issuer Access Control Server (Step 308) and collect the necessary authentication information from the Cardholder. The Merchant may then input the received authentication information into the Access Control Server electronic form (Step 310). The electronic form (or “Virtual Pop-Up”) is preferably provided by the Issuer Authentication Service. The electronic form may be provided via the Internet using a web interface, or may be provided using any software application which would facilitate the secure transfer of data between the Merchant and Issuer.

Next, The Issuer Access Control Server preferably generates a PARes (Step 312) and transmits the PARes to the URL defined in the TermURL element of the PAReq. The Merchant Plug-In may receive the encoded PARes and extract and validate the digital signature (Step 314). In accordance with the 3-D Secure Protocol, the Merchant may then retrieve the Application Authentication Value (AAV) from the PARes and pass the AAV in the authorization message (Step 316). Finally, the Merchant may complete the transaction in accordance with the 3-D Secure protocol or other known transaction protocol (Step 319).

Another exemplary procedure for performing authentication (Step 214 of FIG. 2A) is illustrated in FIG. 3B. In this exemplary embodiment, an Interactive Voice Response (“IVR”) approach is implemented, i.e., wherein the Merchant conducts a transaction over the telephone with a caller/purchaser and transfers the caller/purchaser for authentication purposes to an IVR system which prompts the purchaser for authentication information and performs the necessary authentication steps.

Upon a Cardholder's purchase, the Merchant may communicate via a Merchant Plug-In with the Access Control Server to determine whether the Cardholder is enrolled in authentication services (Step 320). Next, the Issuer may transmit a VERes message which includes a query string parameter “IVRNO” within the ACS (Access Control Server) URL element (Step 322). For example, the following sample URL may be included in the VERes message:
https://securecode.issuer.com/authenticate.asp?IVRNO=IVR
   This additional query string parameter appended to the ACS URL is detected by the Merchant Plug-In and indicates to the Merchant that the Cardholder is enrolled for telephone authentication and that the Merchant must perform IVR authentication.

Next, the Merchant Plug-In may generate a PAReq message and append name/value pairs within the merchant data element to indicate parameters for authentication, for example:
“##authentication-type=IVR;caller-id=14403528444;transfer-back=Y;transfer-number=18004681512##”
   The merchant may then transmit the PAReq to the Issuer Access Control Server (Step 324). For example, the value above may indicate to the Access Control Server that the PAReq transmitted by the Merchant is for telephone authentication as opposed to e-commerce/on-line authentication, that the authentication procedure is IVR, and preferably also provides information such as caller identification information, instructions regarding the telephone number to which the customer should be transferred for IVR authentication, and a TransferBack flag which indicates to the IVR system whether or not the caller should be transferred back to the Merchant upon completion of IVR authentication. The Merchant may then transfer the caller to the phone number provided within the query string to initiate IVR authentication (Step 326). The caller/purchaser may then be transferred to the issuer IVR for authentication (Step 328). Authentication may be performed using numerous different procedures within the scope of the present invention, and may include, e.g., prompting the caller/purchaser to confirm the purchase information and prompting the caller/purchaser to enter/speak authentication information such as the Cardholder's SecureCode. Next, The Issuer Access Control Server may authenticate the caller/purchaser, generate a PARes and transmit the PARes to the URL defined in the TermURL element (Step 330). The Cardholder may be transferred back to the merchant if the TransferBack parameter in the merchant data so dictates. The Merchant Plug-In may then receive the encoded PARes and extract/validate the digital signature (Step 332). In accordance with the 3-D Secure Protocol, the Merchant may then retrieve the AAV from the PARes and pass the AAV in the authorization message (Step 334). Finally, the Merchant may complete the transaction as normal in accordance with a 3-D Secure protocol or other known protocol (Step 336).

It will be appreciated by those skilled in the art that the methods and systems illustrated in FIGS. 1-3 can be implemented using various standard computer platforms operating under the control of suitable software. In some cases, dedicated computer hardware, such as a peripheral card in a conventional personal computer, may be used to enhance the operational efficiency of the above methods.

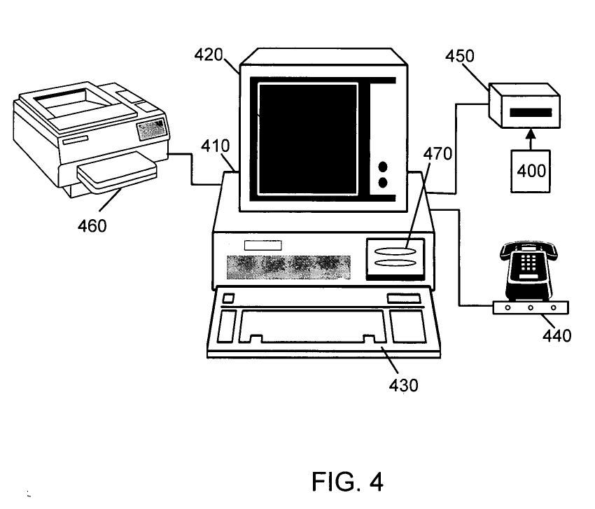

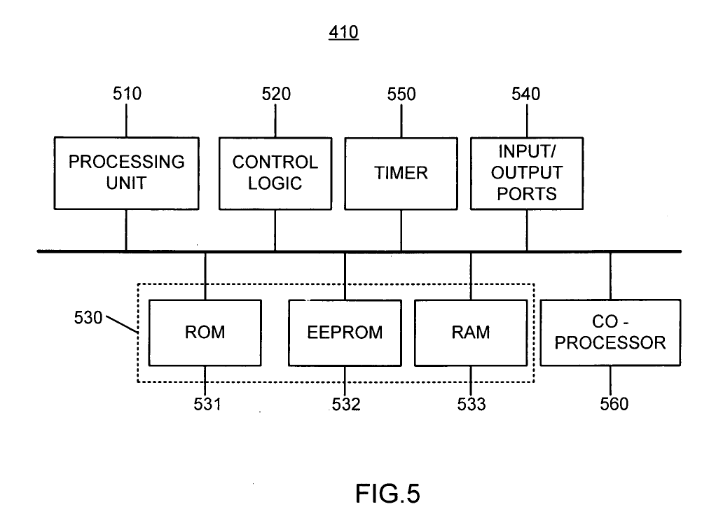

FIGS. 4 and 5 illustrate typical computer hardware suitable for practicing the present invention. Referring to FIG. 4, the computer system includes a processing section 410, a display 420, a keyboard 430, and a communications peripheral device 440 such as a modem. The system can also include a printer 460. The computer system typically includes one or more disk drives 470 which can read and write to computer-readable media such as magnetic media (i.e., diskettes) and/or optical media (e.g., CD-ROMS or DVDs), for storing data and application software. The system also typically includes an internal computer-readable medium 480 such as a hard disk drive. Other input devices, such as a digital pointer 490 (e.g., a mouse) and a card reader 450 for reading a payment card 400 can also be included. Computer hardware such as is illustrated in FIGS. 4 and 5 can be used to execute the software illustrated in FIGS. 1-3, and/or can be used to perform functions of a computer processors utilized by consumer 102, merchant 104 (and the related merchant plug-in discussed hereinabove), acquirer 106, issuer system 108, and directory system 110.

FIG. 5 is a functional block diagram which further illustrates the processing section 410. The processing section 410 generally includes a processing unit 510, control logic 520 and a memory unit 550. Preferably, the processing section 410 can also include a timer 530 and input/output ports 540. The processing section 410 can also include a co-processor 560, depending on the microprocessor used in the processing unit. Control logic 520 provides, in conjunction with processing unit 510, the control necessary to handle communications between memory unit 550 and input/output ports 540. Timer 530 provides a timing reference signal for processing unit 510 and control logic 520. Co-processor 560 provides an enhanced ability to perform complex computations in real time, such as those required by cryptographic algorithms.

Memory unit 550 can include different types of memory, such as volatile and non-volatile memory and read-only and programmable memory. For example, as shown in FIG. 5, memory unit 550 can include read-only memory (ROM) 552, electrically erasable programmable read-only memory (EEPROM) 554, and random-access memory (RAM) 556. Different computer processors, memory configurations, data structures and the like can be used to practice the present invention, and the invention is not limited to a specific platform. For example, although the processing section 410 is illustrated in FIGS. 4 and 5 as part of a computer system, the processing section 410 and/or its components can be incorporated into a PDA or a mobile telephone.

Although the present invention has been described in connection with specific exemplary embodiments, it should be understood that various changes, substitutions, and alterations apparent to those skilled in the art may be made to the disclosed embodiments without departing from the spirit and scope of the invention as set forth in the appended claims.

1. A method for conducting a secure transaction between a merchant and a customer wherein payment is processed from a payment account comprising:
providing a database comprising first authentication information associated with a holder of said payment account;
providing payment account information associated with said payment account, said payment account information to be used for conducting said transaction;
transmitting an authentication request including said payment account information to an access control server;
receiving by a merchant information comprising authentication instructions;
receiving second authentication information from the customer;
comparing said first and said second authentication information to determine whether said transaction is authorized by said holder of said payment account.

2. The method of claim 1 further comprising the step of transmitting an authentication response responsive to said authentication request.

3. The method of claim 2 further comprising the steps of processing payment from said payment account to complete the transaction as a function of said authentication response.

4. The method of claim 1 wherein said payment account information is provided via telephone.

5. The method of claim 1 wherein said payment account information is provided via computer network.

6. The method of claim 2 wherein said authentication request and said authentication response are formatted according to the 3-D Secure authentication protocol.

7. The method of claim 1 wherein said authentication instructions comprise information relating to IVR authentication.

8. The method of claim 1 wherein said authentication instructions comprise information relating to MOBO authentication.

9. A method for conducting a secure transaction using authentication wherein payment is processed from a holder's payment account comprising:
receiving payment account information associated with said payment account, said payment account information to be used for conducting said transaction;
transmitting an authentication request including said payment account information to an access control server, said authentication request triggering automatically by said server the transmission of data used to display an electronic form;
receiving via said electronic form authentication information from said holder;
authenticating said holder for purposes of authorizing said transaction; and
authorizing said transaction.

10. The method of claim 9 further comprising the step of receiving an authentication response responsive to said authentication request.

11. The method of claim 10 further comprising the steps of processing payment from said payment account to complete the transaction as a function of said authentication response.

12. The method of claim 9 wherein said payment account information is provided via telephone.

13. The method of claim 9 wherein said payment account information is provided via computer network.

14. The method of claim 10 wherein said authentication request and said authentication response are formatted according to the 3-D Secure authentication protocol.

15. The method of claim 9 wherein said authentication instructions comprise information relating to IVR authentication.

16. The method of claim 9 wherein said authentication instructions comprise information relating to MOBO authentication.

17. A method for conducting a secure transaction using authentication wherein payment is processed from a payment account comprising:
providing a database comprising at least a first set of authentication information associated with a holder of said payment account;
receiving payment account information associated with said payment account, said payment account information to be used for conducting said transaction;
receiving an authentication request including at least said payment account information in connection with conducting said transaction;
triggering automatically the display of an electronic form;
receiving a second set of authentication information from said holder of said payment account;
inputting said second set of authentication information into said electronic form; and
comparing said first set of authentication information to said second set of authentication information to determine whether said transaction is authorized by said holder of said payment account.

18. The method of claim 17 further comprising the step of providing an authentication response responsive to said authentication request.

19. The method of claim 18 further comprising the steps of processing payment from said payment account to complete the transaction as a function of said authentication response.

20. The method of claim 17 wherein said payment account information is provided via telephone.

21. The method of claim 17 wherein said payment account information is provided via computer network.

22. The method of claim 18 wherein said authentication request and said authentication response are formatted according to the 3-D Secure authentication protocol.

23. A system for conducting a secure transaction comprising:
a server computer subsystem, said server computer subsystem comprising information relating to at least one payment account including at least a first set of authentication information relating to an account holder of said payment account;
an automated voice response subsystem; and
an authentication subsystem,
wherein said automated voice response subsystem connects a call to said account holder to obtain a second set of authentication information, and further wherein said authentication subsystem compares said first set of authentication information to said second set of authentication information to determine whether the transaction is authorized by said account holder.

24. The system of claim 23 wherein the transaction is conducted in accordance with the 3-D Secure protocol.

25. A system for conducting a secure transaction between a merchant and an account holder, comprising:
a server computer subsystem, said server computer subsystem comprising information relating to at least one payment account including at least a first set of authentication information relating to an account holder of said payment account; and
a virtual electronic form subsystem;
wherein said virtual electronic form subsystem provides an electronic form to said merchant, said electronic form receiving a second set of authentication information from said merchant, and further wherein said server computer subsystem compares said first set of authentication information to said second set of authentication information to determine whether the transaction is authorized by said account holder.

26. The system of claim 25 wherein the transaction is conducted in accordance with the 3-D Secure protocol.
